(19) United States
(12) Patent Application Publication
(10) Pub. No.: US 2018/0118909 A1
(43) Pub. Date: May 3, 2018

(54) FOAMABLE, MULTICOMPONENT COMPOSITION WHICH FORMS AN INSULATION LAYER AND USE OF SAID COMPOSITION

(71) Applicant: Hilti Aktiengesellschaft, Schaan (LI)

(72) Inventors: Jekaterina Jeromenok, Ostfildern (DE); Juliane Marauska, Kaltenkirchen (DE); Mario Paetow, Igling (DE)

(73) Assignee: Hilti Aktiengesellschaft, Schaan (LI)

(21) Appl. No.: 15/575,782

(22) PCT Filed: May 20, 2016
(86) PCT No.: PCT/EP2016/061385

§ 371 Date: Nov. 20, 2017

(30) Foreign Application Priority Data
May 21, 2015 (EP) 15168558.3

(51) Int. Cl. C08J 9/08; C08J 9/06; C08J 9/00

(52) U.S. Cl. CPC C08J 9/08; C08J 9/06; C08J 2300/108; C08J 2201/026; C08J 2203/02; C08J 9/0004

(57) ABSTRACT

A foamable, insulating-layer-forming multi-component composition has at least one alkyoxysilane-functional polymer, at least one insulating-layer-forming fire-protection additive, a blowing-agent mixture, and a cross-linking agent. The at least one alkoxysilane-functional polymer contains, as terminal groups and/or as side groups along the polymer chain, alkoxy-functional silane groups of a formula —Si(R¹)ₘ(OR²)₃₋ₘ. In this formula, R¹ stands for a linear or branched C₁-C₁₆ alkyl moiety, R² for a linear or branched C₁-₆ alkyl moiety and m for an integer from 0 to 2. The composition can be a foam-in-place foam or can be used for the manufacture of molded blocks.

The present invention relates to a foamable, insulating-layer-forming multi-component composition and use of the same.

Polyurethanes are often used as binders for mounting, insulating and fire-protection foams. These may be applied, for example, as 1-component, 2-component aerosol cans or as 2-component cartridge foam. In the first case the system needs high atmospheric humidity in order to cure. In the latter two cases, curing is achieved via the polyol/water component. The hardener component, i.e. the isocyanate, has long been regarded as a hazardous substance. Mixtures that contain more than 1% free MDI must be labeled with “carcinogenic category 3; H351”. Especially for foam-in-place foams, which are applied in place by the user, it would be very advantageous if the substances with which the user comes into contact were as harmless as possible.

One solution proposed for this are the so-called “low-MDI foams”, in which isocyanate prepolymers with a content of less than 1% or even 0.1%, for example, are used, such as described, for example, in DE 102010038355 A1 or DE 10357093 A1.

Another proposed solution is based on the use of “modified silanes” (also known as STP, silane-terminated polymer). These polymers, which often have a polyurethane or polyether backbone, cure via hydrolysis and polycondensation reaction of the alkoxysilyl groups. Such foams are commercially available as insulating foams in pressurized cans. The canned foams are generally foamed via a physical blowing agent. Such systems are known, for example, from WO 2000/004069 A1, US 2006/189705 A, WO 2013/107744 A1 or WO 2013/045422 A1.

A disadvantage for fire properties of canned foams that work with physical blowing agents and at the same time function as solvents for the prepolymers is that only low densities can be achieved. In order to generate stable ashes in the fire situation, densities greater than 100 g/L are generally needed, but they can hardly be achieved with conventional canned foams. A further disadvantage is the greatly limited usability, from the can, of fillers, which are necessary for good fire-protection properties, because here the setting behavior, the ease of valve operation and the storage stabilities with the prepolymers are problematic. Another disadvantage is the post-foaming after application of the foam from the can, because the foam reacts further with atmospheric moisture. After the canned foams cure due to atmospheric moisture, curing “in bulk” proceeds only slowly or incompletely, i.e. normal curing on the surface but retarded curing in deeper levels, since moisture is tacking there.

Besides the one-component STP canned foams, two-component or multi-component systems are also known, for example from EP 1829908 A1, EP 2725044 A1 or WO 2014/084039 A1. However, the known STP canned foams and two-component systems are not fire-protection foams and do not contain any fire-protection additives.

The object underlying the invention is to provide foams, especially foam-in-place foams, which do not exhibit the said disadvantages of the known systems and which are suitable for fire protection.

This object is solved by the composition according to claim 1. Preferred embodiments can be found in the dependent claims.

Subject matter of the invention is accordingly a foamable, insulating-layer-forming multi-component composition with at least one alkoxysilane-functional polymer, which contains, as terminal groups and/or as side groups along the polymer chain, alkoxy-functional silane groups of the general formula (I)

—Si(R¹)ₘ(OR²)₃₋ₘ (I),

wherein R¹ stands for a linear or branched C₁-C₁₅ alkyl moiety, R² for a linear or branched C₁-C₆ alkyl moiety and m for a whole number from 0 to 2, with at least one insulating-layer-forming fire-protection additive, with a blowing-agent mixture and with a cross-linking agent.

According to the invention, the individual ingredients of the blowing-agent mixture are separated from one another to ensure inhibition of reaction prior to use of the composition. Furthermore, the cross-linking agent is separated from the alkoxysilane-functional polymer to ensure inhibition of reaction prior to use of the composition, in order to prevent curing of the polymer prior to use of the composition.

Within the meaning of the invention, a polymer is a molecule with six or more repeating units, which may have a structure that can be linear, branched, star-shaped, coiled, hyperbranched or cross-linked. Polymers may contain a single type of repeating units (“homopolymers”) or they may contain more than one type of repeating units (“copolymers”). As used herein, the term “polymer” comprises both prepolymers, which may also include oligomers with 2 to 5 repeating units, such as the alkoxysilane-functional compounds used as ingredient A, which react with one another in the presence of water with formation of Si—O—Si bonds, and also the polymeric compounds formed by the reaction just mentioned.

For better understanding of the invention, the following explanations of the terminology used herein are considered to be useful. Within the meaning of the invention:
“chemical intumescence” means the formation of a voluminous insulating ash layer by compounds that are appropriately matched to one another and that react with one another under the effect of heat;
“physical intumescence” means the formation of a voluminous insulating layer by swelling of a compound, which releases gases under the effect of heat, even though no chemical reaction has occurred between two compounds, whereby the volume of the compound increases by a multiple of the original volume;
“insulation-layer-forming” means that, in the fire situation, a solid microporous carbon foam is produced, so that the resulting finely porous and thick foam layer, the so-called ash crust, insulates a substrate against heat, depending on composition;
a “carbon source” is an organic compound which, due to incomplete combustion, leaves behind a carbon skeleton and is burned incompletely to carbon dioxide and water (carbonization); these compounds are also known as “carbon-skeleton-forming substances”;
an “acid former” is a compound which, under the effect of heat, i.e. above approximately 150° C., forms a nonvolatile acid, for example due to decomposition, and thereby acts as a catalyst for carbonization; in addition, it may contribute to lowering the viscosity of the melt of binder; the term “dehydrogenation catalyst” is used synonymously in this context;
a “gas builder” is a compound that decomposes at elevated temperature with evolution of inert, i.e., noncombustible gases and optionally expands the softened binder info a foam (intumescence);
an “ash-crust stabilizer” is a so-called skeleton-forming compound, which stabilizes the carbon skeleton (ash crust) formed by the interaction of carbon formation from the carbon source and the gas from the gas builder or by physical intumescence.

According to the invention, the alkoxysilane-functional polymer comprises a basic backbone, which is selected from the group consisting of a polyether, polyester, polyether ester, polyamide, polyurethane, polyester urethane, polyether urethane, polyether ester urethane, polyamide urethane, polyurea, polyamine, polycarbonate, polyvinyl ester, polyacrylate, polyolefin, such as polyethylene or polypropylene, polyisobutylene, polysulfide, rubber, neoprene, phenol resin, epoxy resin, melamine. This basic backbone may have linear or branched structure (linear basic backbone with side chains along the chain of the basic backbone), and may contain terminal alkoxy-functional silane groups, i.e. as end groups of a linear basic backbone or as end groups of the linear basic backbone and as end groups of the side groups, preferably at least two alkoxy-functional silane groups.

The alkoxy-functional silane group has the general formula (I)

—Si(R¹)ₘ(OR²)₃₋ₘ (I),

wherein R¹ stands for a linear or branched C₁-C₁₆ alkyl moiety, preferably for a methyl or ethyl moiety, R² for a linear or branched C₁-C₆ alkyl moiety, preferably for a methyl or ethyl moiety, and m for an integer from 0 to 2, preferably 0 or 1. Most preferably, the at least two alkoxy-functional silane groups are difunctional (m=1) or trifunctional (m=0), and the alkoxy group is a methoxy or ethoxy group.

Preferably the alkoxy-functional silane group is bound to the basic backbone via group, such as a further, different functional group (X=—S—, —OR, —NHR, —NR₂, for example), which either is able itself to function as an electron donor or contains an atom that is able to function as an electron donor, wherein the two functional groups, i.e. the further functional group and the alkoxy-functional silane group, are bound to one another via a methylene bridge (—X—CH₂—Si(R¹)ₘ(OR²)₃₋ₘ). Hereby an electronic interaction (backbonding) is induced between the silicon atom and the electron donor, wherein electron density is shifted from the donor to the silicon atom, leading to weakening of the Si—O bond and in turn resulting in greatly increased reactivity of the Si-alkoxy groups. This is known as the so-called α-effect. Such compounds are also known as α-silanes. Besides this, however, so-called γ-silanes or other kinds of silanes may also be used.

The most preferred alkoxysilane-functional polymers are polymers in which the basic backbone is terminated via a urethane group or an ether group containing silane groups, such as, for example dimethoxy(methyl)silylmethyl carbamate-terminated polyether, diethoxy(methyl)silylmethyl carbamate-terminated polyether, trimethoxysilylmethyl carbamate-terminated polyether, triethoxysilylmethyl carbamate-terminated polyether, or mixtures thereof.

Examples of suitable polymers comprise silane-terminated polyether (e.g. Geniosil® STP-E 10 and Geniosil® STP-E 30 of Wacker Chemie AG; MS polymers of Kaneka Corporation (especially MS-203, MS-303, SAX260, SAX350, SAX400, SAX220, S154, S327, S227, SAX725, SAX510, SAX520, SAX530, SAX580, SAT010, SAX015, SAX770, SAX220, SAX115, (polyether backbone)) and silane-terminated polyurethanes (e.g. Polymer ST61, Polymer ST75 and Polymer ST77 of Evonik Hanse, Desmoseal® S XP 2458, Desmoseal® S XP 2636, Desmoseal® S XP 2749, Desmoseal® S XP 2821 of Bayer, SPUR+*1050MM, SPUR+*1015LM, SPUR+*3100HM SPUR+*3200HM Of Momentive).

As alternative polymers, such in which the alkoxy-functional silane groups are incorporated not (only) terminally in the backbone of the polymer, but are selectively distributed in side positions over the chain of the basic backbone, may be preferably used. Important properties, such as the cross-linking density, can be controlled via the incorporated several cross-linking units. Suitable examples that may be mentioned here are the TEGOPAC® product line of Evonik Goldschmidt GmbH, such as TEGOPAC BOND 150, TEGOPAC BOND 250 and TEGOPAC SEAL 100, as well as GENIOSIL® XB 502, GENIOSIL® WP1 and GENIOSIL® WP2 of Wacker Chemie AG. In this connection, reference is made, for example, to DE 102008000360 A1, DE 102009028640 A1, DE 102010038768 A1 and DE 102010038774 A1.

The alkoxysilane-functional polymer may also be a mixture of two or more of the polymers that are described in the foregoing and that may be similar or different.

Depending on chain length of the basic backbone, alkoxy functionality of the polymer and position of the alkoxy-functional silane groups, the degree of cross-linking of the binder and thus both the strength of the resulting coating and its elastic properties can be adjusted.

Usually the proportion of binder amounts to 10 to 70 wt %, preferably 15 to 65 wt %, more preferably 20 to 55 wt %, respectively relative to the total composition.

According to the invention, the composition contains a cross-linking agent, especially water. Hereby more homogeneous and faster full curing of the binder is achieved, compared with a system that cures due to the atmospheric moisture in the environment. Thus the curing of the composition is largely independent of the absolute atmospheric humidity, and the composition cures reliably and rapidly even under extremely dry conditions.

The water content in the composition is preferably between 5 and 40 wt %, more preferably between 10 and 30 wt %, relative to the total composition.

As blowing agents, all common chemical blowing agents that are activated by chemical reaction between two ingredients are suitable, i.e. that form a gas as the actual blowing agent. Accordingly, the composition contains, according to the invention, a blowing-agent mixture, which comprises compounds that, after being mixed, react with one another with formation of carbon dioxide (CO₂), hydrogen (H₂) or oxygen (O₂).

In one embodiment, the blowing-agent mixture comprises an acid and a compound that is able to react with acids to form carbon dioxide.

Carbonate-containing and hydrogen-carbonate-containing compounds, especially metal or (especially quaternary) ammonium carbonates may be used as compounds that are able to react with acids to form carbon dioxide, such as carbonates of alkali or alkaline earth metals, for example CaCO₃, NaHCO₃, Na₂CO₃, K₂CO₃, (NH₄)₂CO₃ and the like, wherein chalk (CaCO₃) is preferred. In this connection, various types of chalks with different grain sizes and different surface texture can be used, such as, for example, coated or uncoated chalk, or mixtures of two or more of those. Coated chalk types are preferably used, since they react more slowly with the acid and thus ensure controlled foaming or matched foaming and curing time.

As acid, any acid compound capable of reacting with carbonate-containing or hydrogen carbonate-containing compounds with elimination of carbon dioxide may be used, such as, for example, phosphoric acid, hydrochloric acid, sulfuric acid, ascorbic acid, polyacrylic acid, benzoic acid, toluenesulfonic acid, tartaric acid, glycolic acid, lactic acid, organic mono-, di- or polycarboxylic acids, such as acetic acid, chloroacetic acid, trifluoroacetic acid, fumaric acid, maleic acid, citric acid or the like, aluminum dihydrogen phosphate, sodium hydrogen sulfate, potassium hydrogen sulfate, aluminum chloride, urea phosphate and other acid-liberating chemicals or mixtures of two or more thereof. The acid generates the gas as the actual blowing agent.

As the acid component, an aqueous solution or an inorganic and/or organic acid may be used. Furthermore, buffered solutions of citric, tartaric, acetic, phosphoric acid and the like may be used.

According to the invention, the content of acid components in the composition may be as high as 41 wt % relative to the polymer, preferably a content in the range between 10 and 35 wt %, more preferably between 15 and 30 wt % and even more preferably between 18 and 28 wt %.

In an alternative embodiment, the blowing-agent mixture comprises compounds that evolve hydrogen when they react with one another. The following reactions are possible for this purpose:

(i) one or more base metals (e.g. aluminum, iron or zinc) with bases (e.g. one or more alkali metal hydroxides, such as sodium, potassium or lithium hydroxide) or with one or more acids, such as defined above for the carbonates (preferably inorganic acids);

(ii) metal hydrides (e.g. sodium hydride or lithium aluminum hydride) with water, or

(iii) a compound that contains Si-bound hydrogen atoms (e.g. polymethyl hydrogen siloxane, also known as polymethylhydrosiloxane, but also other polyalkyl- or polyaryl hydrogen siloxanes) with proton donors (e.g. water). Among other possibilities, polyhydrogen siloxanes, tetramers, copolymers of dimethysiloxane and methylhydrosiloxane, trimethylsilyl-terminated polyhydrogen siloxanes, hydride-terminated polydimethylsiloxanes, triethylsilyl-terminated polyethylhydrosiloxanes, hydride-terminated copolymers of polyphenylmethylsiloxane and methylhydrosiloxane and the like are suitable.

These compounds are preferably present in a proportion of 0.1 to 15 wt %, more preferably 3 to 13 wt % and most preferably 4 to 7 wt %, relative to the total composition.

In a further alternative embodiment, the blowing-agent mixture comprises compounds that are able to evolve oxygen when they react, such as, for example, by the reaction of peroxides (e.g. hydrogen peroxide or compounds that release hydrogen peroxide, including solid compounds such as hydrogen peroxide-urea complex and urea phosphate) with metal oxides and/or bases.

These compounds are preferably present in a proportion of 0.1 to 5 wt %, more preferably 1.5 to 4 wt % and most preferably 2 to 3 wt %, relative to the total composition.

According to the invention, the composition contains an insulating-layer-forming additive, wherein the additive may comprise both an individual compound and also a mixture of several compounds.

Expediently, the compounds used as insulating-layer-forming additives are such that, due to the formation of an expanded, insulating layer of flame-retardant material formed under the effect of heat, they protect the substrate from overheating and thereby prevent or at least delay the change of the mechanical and static properties of load-bearing building parts under the effect of heat. The formation of a voluminous insulating layer, namely an ash layer, may take place due to the chemical reaction of a mixture of compounds that are appropriately matched to one another and that react with one another under the effect of heat. Such systems are known to the person skilled in the art as chemical intumescence, and they may be used according to the invention. Alternatively, the voluminous, insulating layer may be formed by physical intumescence. According to the invention, the two systems may be used respectively alone or together as a combination.

In general, at least three components are required for the formation of an intumescent layer by chemical intumescence: a carbon source, a dehydrogenation catalyst and a gas builder, which in many cases are contained in a binder. Under the effect of heat, the binder softens and the fire-protection additives are released, so that they are able to react with one another in the case of chemical intumescence or to expand in the case of physical intumescence. From the dehydrogenation catalyst, the acid that functions as catalyst for the carbonization of the carbon source is formed by thermal decomposition. At the same time, the gas builder decomposes thermally with formation of inert gases, which bring about expansion of the carbonized (charred) material, as does optionally the softened binder, with formation of a voluminous, insulating foam.

In one embodiment of the invention, in which the insulating layer is formed by chemical intumescence, the insulating-layer-forming additive comprises at least one carbon-skeleton-forming substance, if the binder cannot be used as such, at least one acid former, at least one gas builder and at least one inorganic skeleton-forming substance. The components of the additive are selected in particular such that they are able to develop synergy, wherein some of the compounds are able to perform several functions.

As carbon source, the compounds usually used in intumescent flame-protection agents and known to the person skilled in the art can be considered, such as starch-like compounds, e.g. starch and modified starch, and/or polyhydric alcohols (polyols), such as saccharides and polysaccharides and/or a thermoplastic or thermosetting polymeric resin binder, such as a phenol resin, a urea resin, a polyurethane, polyvinyl chloride, poly(meth)acrylate, polyvinyl acetate, polyvinyl alcohol, a silicone resin and/or a rubber. Suitable polyols are polyols from the group comprising sugar, pentaerythritol, dipentaerythritol, tripentaerythritol, polyvinyl acetate, polyvinyl alcohol, sorbitol, EO-PO-polyols. Pentaerythritol, dipentaerythritol or polyvinyl acetate are preferably used.

It must be mentioned that the polymer that acts as binder may itself also have the function of a carbon source in the fire situation, so that the inclusion of an additional carbon source is not always necessary.

The compounds commonly used in intumescent fire-protection formulations and known to the person skilled in the art, such as a salt or an ester of an inorganic, nonvolatile acid selected from among sulfuric acid, phosphoric acid or boric acid, may be considered as the dehydrogenation catalysts or acid formers. Mainly phosphorus-containing compounds, the range of which is very broad, are used, since they extend over several oxidation states of phosphorus, such as phosphines, phosphine oxides, phosphonium compounds, phosphates, elemental red phosphorus, phosphites and phosphates. As examples of phosphoric acid compounds, the following can be mentioned: monoammonium phosphate, diammonium phosphate, ammonium phosphate, ammonium polyphosphate, melamine phosphate, melamine resin phosphates, potassium phosphate, polyol phosphates such as, for example, pentaerythritol phosphate, glycerol phosphate, sorbitol phosphate, mannitol phosphate, duicitol phosphate, neopentyl glycol phosphate, ethylene glycol phosphate, dipentaerythritol phosphate and the like. Preferably a polyphosphate or an ammonium polyphosphate is used as the phosphoric acid compound. In this connection, compounds such as reaction products of lamelite C (melamine-formaldehyde resin) with phosphoric acid can be understood as melamine resin phosphates. As examples of sulfuric acid compounds, the following may be mentioned: ammonium sulfate, ammonium sulfamate, nitroaniline bisulfate, 4-nitroaniline-2-sulfonic acid and 4,4-dinitrosulfanilamide and the like. As an example of boric acid compounds, melamine borate may be mentioned.

As gas builders, the compounds commonly used in flame-protection agents and known to the person skilled in the art may be considered, such as cyanuric acid or isocyanuric acid and derivatives thereof, melamine and derivatives thereof. These include cyanamide, dicyanamide, dicyandiamide, guanidine and its salts, biguanide, melamine cyanurate, cyanic acid salts, cyanic acid esters and amides, hexamethoxymethyl melamine, dimelamine pyrophosphate, melamine polyphosphate, melamine phosphate. Preferably, hexamethoxymethyl melamine or melamine (cyanuric acid amide) are used.

Furthermore, components that do not restrict their mode of action to a single function are suitable, such as melamine polyphosphate, which acts both as an acid former and as a gas builder. Further examples are described in GB 2 007 689 A1, EP 139 401 A1 and U.S. Pat. No. 3,969,291 A1.

In one embodiment of the invention, in which the insulating layer is formed by physical intumescence, the insulating-layer-forming additive comprises at least one thermally expandable compound, such as a graphite intercalation compound, which compounds are also known as expandable graphite. These may likewise be contained in the binder, especially homogeneously.

Intercalation compounds of SOₓ, NOₓ, halogen and/or strong acids in graphite can be considered as examples of expandable graphite. These are also referred to as graphite salts. Expandable graphites that evolve SO₂, SO₃, NO and/or NO₂ while expanding at temperatures of 120 to 350° C., for example, are preferred. As an example, the expandable graphite may be available in the form of lamellas with a maximum diameter in the range of 0.1 to 5 mm. Preferably this diameter lies in the range of 0.5 to 3 mm. Expandable graphite suitable for the present invention are commercially available. In general, the expandable-graphite particles are uniformly distributed in the inventive fire-protection elements. However, the concentration of expandable-graphite particles may also be varied in the manner of spots, patterns, areas or sandwiches. In this respect, reference is made to EP 1489136 A1, the contents of which are incorporated herewith in the present Application.

In a further embodiment of the invention, the insulating layer is formed both by chemical and by physical intumescence, so that the insulating-layer-forming additive comprises both a carbon source, a dehydrogenation catalyst and a gas builder as well as thermally expandable compounds.

In addition, the insulating-layer-forming fire-protection additive contributes to increasing the density of the foams, since hereby the fire-protection properties can be improved. The foams generally have densities of approximately 180-300 g/cm³, measured in accordance with DIN EN ISO 845.

The insulating-layer-forming additive may be contained in a proportion of 10 to 70 wt % in the composition. In order to achieve the highest possible intumescence rate, the proportion of the insulating-material-forming additive in the total formulation is adjusted to the highest possible level, but care must be taken that the viscosity of the composition is not too high, so that the composition can still be processed readily. The proportion is preferably 12 to 60 wt %, and particularly preferably 15 to 30 wt %, relative to the total composition.

Since the ash crust formed in the fire situation is usually too unstable and, depending on its density and structure, it can be blasted by air streams, for example, which negatively influences the insulating effect of the coating, at least one ash-crust stabilizer is preferably added to the compounds just listed. In this connection, the mode of action is in principle that the inherently soft carbon layers being formed are mechanically strengthened by inorganic compounds. The addition of such an ash-crust stabilizer contributes to substantial stabilization of the intumescent crust in the fire situation, since these additives increase the mechanical strength of the intumescent layer and/or prevent it from dripping.

The compounds commonly used in fire-protection formulations and known to the person skilled in the art, for example expandable graphite and particulate metals, such as aluminum, magnesium, iron and zinc, may be considered as ash-crust stabilizers or skeleton-forming substances. The particulate metal may exist in the form of a powder, lamellas, flakes, fibers, filaments and/or whiskers, wherein the particulate metal in the form of powder, lamellas or flakes preferably has a particle size of<50 μm, preferably of 0.5 to 10 μm. In the case that the particulate metal is used in the form of fibers, filaments and/or whiskers, a thickness of 0.5 to 10 μm and a length of 10 to 50 μm are preferred. Alternatively or additionally, an oxide or a compound of a metal from the group comprising aluminum, magnesium, iron or zinc may be used as the ash-crust stabilizer, especially iron oxide, preferably ferric oxide, titanium dioxide, a borate, such as zinc borate and/or a glass frit of low-melting glasses with a melting temperature of preferably 400° C. or above, phosphate or sulfate glasses, melamine poly(zinc sulfates), ferroglasses or calcium bore silicates. The addition of such an ash-crust stabilizer contributes to substantial stabilization of the ash crust in the fire situation, since these additives increase the mechanical strength of the intumescent layer and/or prevent it from dripping. Examples of such additives can also be found in U.S. Pat. No. 4,442,157 A, U.S. Pat. No. 3,582,197 A, GB755 551 A and EP 138 546 A1.

In addition, ash-crust stabilizers such as melamine phosphate or melamine borate may be present.

Optionally, one or more flame-retardant agents may be added to the inventive composition, such as phosphate esters, halogen-containing compounds such as, for example tri-(2-chloroisopropyl) phosphate (TCPP), tris(2-ethylhexyl) phosphate, dimethyl propane phosphonate, triethyl phosphate and the like. Some compounds of this type are described, for example, in S. V Levchik, E. D Weil, Polym. Int. 2004, 53, 1901-1929. The flame-retardant agent may be present preferably in a proportion of 3 to 8 wt % relative to the total composition.

The inventive composition may contain at least one catalyst. Hereby the curing of the binder (polymer) can be accelerated, in which case sagging or collapse of the formed foam can be prevented or at least greatly slowed. Because of the fester skin formation on the surface of the foamed composition, the catalyst also causes the surface to remain tacky over a shorter period.

All compounds that are suitable for catalyzing the formation of Si—O—Si bonds between the silane groups of the polymer may be used as catalysts. For example, it is possible to mention metal compounds such as titanium compounds, for example titanate esters, such as tetrabutyl titanate, tetrapropyl titanate, tetraisopropyl titanate, tetraacetylacetonate titanate, tin compounds, such as dibutyltin dilaurate, dibutyltin maleate, dibutyltin diacetate, dibutyltin dioctanoate, dibutyltin acetylacefonate, dibutyltin oxide, or corresponding compounds of dioctyltin, tin naphthenate, dimethyltin dineododecanoate, reaction products of dibutyltin oxide and phthalic acid esters, organoaluminum compounds, reaction products of bismuth salts or chelate compounds, such as zirconium tetracetylacetonate.

These catalysts may be used independently of the selected blowing agent for foam formation.

If a catalyst is used, it may be contained in the compositions in a proportion of up to 5 wt %, preferably of 0% to 4 wt % and more preferably of 0% to 0.5 wt %, relative to the total composition.

Alternatively, it is also possible to use other catalysts, especially since some of the foregoing catalysts are questionable in terms of their toxicity. These are, for example, acid or basic catalysts. However, these catalysts are not independent of the blowing agent and must be selected appropriately. Furthermore, it must be considered, especially as regards the quantity thereof to be used, that the catalysts may optionally be used as reagent in the reaction to form the blowing agent, and therefore will be consumed.

For the case that carbon dioxide is to be used as the blowing agent, acid catalysts, such as citric acid, phosphoric acid or phosphoric acid esters, toluenesulfonic acids and other mineral acids are used as catalysts alternatively or in addition to the above-mentioned metal compounds. The acid acts additionally as accelerator for the curing reaction of the binder, by accelerating the hydrolysis and condensation of alkoxysilane groups. Thus the curing of the composition is largely independent of the absolute atmospheric humidity, and the composition cures reliably and rapidly even under extremely dry conditions. The toluenesulfonic acids, which result in extremely rapid curing even without the use of a further catalyst, are suitable in particular for this purpose.

For the case that hydrogen is to be formed as the blowing agent, basic catalysts, such as simple bases, e.g. NaOH, KOH, K₂CO₃, ammonia, Na₂CO₃, aliphatic alcoholates or K phenolate, organic amines, such as triethylamine, tributylamine, trioctylamine, monoethanolamine, diethanolamine, triethanolamine, thisopropanolamine, tetramethylenediamine, Quadrol, diethylenetriamine, dimethylaniline, proton sponge, N,N′-bis[2-(dimethylamino)ethyl]-N,N′-dimethylethylene diamine, N,N-dimethylcyclohexylamine, N-dimethylphenylamine, 2-methylpentamethylene diamine, 2-methylpentamethylene diamine, 1,1,3,3-tetramethylguanidine, 1,3-diphenylguanidine, benzamidine, N-ethylmorpholine, 2,4,6-tris(dimethylaminomethyl)phenol (TDMAMP); 1,8-diazabicyclo[5.4.0]undec-7-ene (DBU) and 1,5-diazabicyclo(4.3.0)non-5-ene (DBN); n-pentylamine, n-hexylamine, di-n-propylamine and ethylenediamine; DABCO, DMAP, PMDETA, imidazole and 1-methylimidazole or salts of amines and carboxylic acids and polyether amines, such as polyether monoamines, polyether diamines or polyether triamines, such as, for example, the Jeffamines of Huntsman and ether amines, such as, for example the Jeffkats of Huntsman, optionally as (aqueous) solution respectively, may be used as catalyst alternatively or in addition to the metal compounds mentioned hereinabove. In this respect, reference is made to the Applications WO 2011/157562 A1 and WO 2013/003053 A1.

The type and quantity of catalyst are selected as a function of the selected alkoxysilane-functional polymer, of the desired reactivity and of the desired blowing agent.

In order to impart greater stability to the formed foam, the formed cells must remain stable until curing of the binder, in order to prevent collapse of the polymeric foam structure. Stabilization is all the more necessary the lower the density of the foamed material is to be, i.e. the greater the volume expansion is. Stabilization is usually achieved by means of foam stabilizers.

To the extent necessary, therefore, the inventive composition may further contain a foam stabilizer. Alkylpolyglycosides, for example, are suitable as foam stabilizers. These are available according to methods known in themselves to the person skilled in the art, by reaction of longer-chain monohydric alcohols with mono-, di- or polysaccharides. The longer-chain monohydric alcohols, which optionally may also be branched, preferably have 4 to 22 C atoms, preferably 8 to 18 C atoms and particularly preferably 10 to 12 C atoms in an alkyl moiety. Specifically, 1-butanol, 1-propanol, 1-hexanol, 1-octanol, 2-ethythexanol, 1-decanol, 1-undecanol, 1-dodecanol (lauryl alcohol), 1-tetradecanol (myristyl alcohol) and 1-octadecanol (stearyl alcohol) may be mentioned as longer-chain monohydric alcohols. Mixtures of the said longer-chain monohydric alcohols may also be used. Further foam stabilizers comprise anionic, cationic, amphoteric and nonionic surfactants known in themselves as well as mixtures thereof. Preferably, alkyl polyglycosides, EO/PO block copolymers, alkyl- or aryl alkoxylates, siloxane alkoxylates, esters of sulfosuccinic acid and/or alkali or alkaline earth metal alkanoate are used. EO/PO block copolymers are used particularly preferably.

The foam stabilizers may be contained in any one of the components of the inventive composition, as long as they do not react with one another.

Furthermore, the composition may contain a further cross-linking agent (co-cross-linking agent). Hereby various properties, such as adhesion to the underlying surface and better wetting of the additives as well as improved curing rate of the composition can be selectively optimized and tailored to the situation.

Suitable further cross-linking agents (co-cross-linking agents) are selected from among a reactive alkoxysilane or an oligomeric organofunctional alkoxysilane. Preferably the further cross-linking agent is an oligomeric vinyl-functional alkoxysilane, an oligomeric amino-/alkyl-functional alkoxysilane, an oligomeric amino-functional alkoxysilane, an amino-functional alkoxysilane, an alkyl-functional alkoxysilane, an epoxy-functional alkoxysilane, a vinyl-functional alkoxysilane, a vinyl-alkyl-functional alkoxysilane, a mercapto-functional alkoxysilane, a methacryl-functional alkoxysilane or a silicic acid ester.

Examples of suitable further cross-linking agents are: hexadecyltrimethoxysilane, iso-butyltriethoxysilane, iso-butyltrimethoxysilane, methyltriethoxysilane, methyltrimethoxysilane, octyltrichlorosilane, octyltriethoxysilane, propyltriethoxysilane, propyltrimethoxysilane, bis(3-triethoxysilylpropyl)amine, bis(3-trimethoxysilylpropyl)amine, 3-aminopropylmethyldiethoxysilane, 3-aminopropyltriethoxysilane, 3-aminopropyltrimethoxysilane, 2-aminoethyl-3-amino-propylmethyldimethoxysilane, 2-aminoethyl-3-amino-propyltrimethoxysilane, 3-glycidyloxypropyltriethoxysilane, 3-glycidyloxypropyltrimethoxysilane, 3-mercaptoprobyltrimethoxysilane, 3-methacryloxypropyltrimethoxysilane, (methacryloxymethyl)methyldimethoxysilane, (methacryloxymethyl)trimethoxysilane, 3-methacryloxypropyltriacetoxysilane, ethyl polysilicate tetraethyl orthosilicate, tetramethyl orthosilicate, tetra-n-propyl orthosilicate, vinyltrichlorsilane, vinyltriethoxysilane, vinyltrimethoxysilane, vinyltriacetoxysilane, vinyltris(2-methoxyethoxy)silane, N-cyclohexylaminomethyltriethoxysilane, cyclohexyl-3-aminopropyltrimethoxysilane, N-(2-aminoethyl)-3-aminopropyltrimethoxysilane, 3-(2-aminomethylamino)propyltriethoxysilane, N-(2-aminoethyl)-3-amino-propylmethyldimethoxysilane, 3-ureidopropyltrimethoxysilane, N-methyl[3-(trimethoxysilyl)propyl]carbamate, N-trimethoxysilylmethyl-O-methylcarbamate, N-dimethoxy(methyl)silyl-methyl-O-methylcarbamate, tris-[3-(trimethoxysilyl)propyl]-isocyanurate or combinations thereof.

If a further cross-linking agent (co-cross-linking agent) is used, it may be contained individually or as a mixture of several such agents in a proportion of 10 wt %, preferably of up to 7 wt % and most preferably of up to 5 wt %, relative to the total composition.

In one embodiment, the inventive composition further contains at least one further ingredient, selected from among plasticizers, cross-linking agents, water scavengers, organic and/or inorganic aggregates and/or further additives.

The plasticizer has the purpose of making the polymer network soft. Furthermore, the plasticizer has the purpose of introducing an additional liquid component, so that the fillers are completely wetted and the viscosity is adjusted to the point that the coating becomes processable. The plasticizer may be contained in such a proportion in the composition that it is adequately able to fulfill the functions just described.

Suitable plasticizers are selected from among derivatives of benzoic acid, phthalic acid, e.g. phthalates such as dibutyl-, dioctyl-, dicyclohexyl-, diisooctyl-, diisodecyl-, dibenzyl- or butylbenzyl phthalate, trimellitic acid, pyromellitic acid, adipic acid, sebacic acid, fumaric acid, maleic acid, itaconic acid, caprylic acid and citric acid, alkyl phosphate esters and derivatives of polyesters and polyethers, epoxidized oils, C₁₀-C₂₁ alkylsulfonic acid esters of phenol and alkyl esters. Preferably, the plasticizer is an ester derivative of terephthalic acid, a triol ester of caprylic acid, a glycol diester, diol esters of aliphatic dicarboxylic acids, ester derivatives of citric acid, secondary alkylsulfonic acid esters, ester derivatives of glycerol with epoxy groups and ester derivatives of the phosphates. More preferably, the plasticizer is bis(2-ethylhexyl) terephthalate, trihydroxymethylpropyl caprylate, triethylene glycol-bis(2-ethylhexanoate), 1,2-cyclohexanedicarboxylic acid diisononyl ester, a mixture of 75-85% secondary alkylsulfonic acid esters, 15-25 % secondary alkanedisulfonic acid diphenyl esters as well as 2-3 % non-sulfonated alkanes, triethyl citrate, epoxidized soya bean oil, tri-2-ethylhexyl phosphate or a mixture of n-octyl- and n-decyl succinate. Most preferably, the plasticizer is a phosphate ester, since this is able to act both as a plasticizer and as a flame retardant.

Within the composition, the plasticizer may be present preferably in a proportion of up to 40 wt %, more preferably up to 35 wt % and even more preferably up to 15 wt %, relative to the total composition.

In order to prevent a premature reaction of the alkoxysilane-functional polymer with residual moisture of ingredients that may be present in the composition, especially fillers and/or additives, or with the atmospheric moisture, usually water scavengers are added to the composition. Thereby the moisture introduced into the formulations is scavenged. Preferably, the water scavenger is an organofunctional alkoxysilane or an oligomeric organofunctional alkoxysilane, more preferably a vinyl-functional alkoxysilane, an oligomeric vinyl-functional alkoxysilane, a vinyl-/alkyl-functional alkoxysilane, an oligomeric amino-/alkyl-functional alkoxysilane, an acetoxy-/alkyl-functional alkoxysilane, an amino-functional alkoxysilane, an oligomeric amino-functional alkoxysilane, a carbamatosilane, an arylalkoxysilane or a methacryloxy-functional alkoxysilane. Most preferably, the water scavenger is di-tert-butoxydiacetoxysilane, bis(3-triethoxysilylpropyl)amine, bis(3-trimethoxypropyl)amine, 3-aminopropylmethyldiethoxysilane, 3-aminopropyltriethoxysilane, vinyltriethoxysilane, vinyltrimethoxysilane, vinyltris(2-methoxyethoxy)sliane, N-cyclohexylaminomethyltriethoxysilane, vinyldimethoxymethylsilane, vinyltriacetoxysilane, 3-methacryloxypropyltrimethoxysilane, (methacryloxymethyl)methyldimethoxysilane, methacryloxymethyltrimethoxysilane, 3-methacryloxypropyltriacetoxysilane, N-methyl[3-(trimethoxysilyl)propy]carbamate, N-trimethoxysilylmethyl-O-methylcarbamate, N-dimethoxy(methyl)silyl-methyl-O-methylcarbamate, phenyltrimethoxysilane or combinations thereof.

The added proportion of water scavenger is guided by the water content of the ingredients of the formulation, except for the specially added water (ingredient B), and it usually lies in the range up to 4 wt %. The water scavenger may be present in a proportion of 0.1 to 4 wt %, preferably 0.8 to 3 wt % and more preferably 0.8 to 2.5 wt %, relative to the total composition.

Besides the already described additives, the composition may optionally contain common auxiliary agents, such as wetting agents, for example on the basis of polyacrylates and/or polyphosphates, dyes, fungicides, or diverse fillers, such as vermiculite, inorganic fibers, silica sand, glass microbeads, mica, silicon dioxide, mineral wool and the like.

Further additives such as thickeners and/or rheology additives and fillers may be included in the composition. Preferably polyhydroxycarboxylic acid amides, urea derivatives, salts of unsaturated carboxylic acid esters, alkylammonium salts of acid phosphoric acid derivatives, ketoximes, amine salts of p-toluenesulfonic acid, amine salts of sulfonic acid derivatives as well as aqueous or organic solutions of mixtures of the compounds are used as rheology additives, such as anti-settling agents, anti-sagging agents and thixotropic agents. Rheology additives on the basis of fumed or precipitated silicas or on the basis of silanized fumed or precipitated silicas may be used. Preferably the rheology additive is fumed silicas, modified and non-modified layer silicates, precipitated silicas, cellulose ethers, polysaccharides, PU and acrylate thickeners, urea derivatives, castor oil derivatives, polyamides and fatty acid amides and polyolefins, provided they exist in solid form, pulverized celluloses and/or suspension agents, such as xanthan gum, for example.

The inventive composition may be packaged as a two-component or multi-component system, wherein the term multi-component system also includes two-component systems. The composition is preferably packaged as a two-component system, in which the individual ingredients of the blowing-agent mixture are separated from one another to ensure inhibition of reaction prior to use of the composition, and the cross-linking agent is separated from the alkoxysilane-functional polymer to ensure inhibition of reaction prior to use of the composition. Depending on their compatibility with one another and with the compounds contained in the composition, the further ingredients of the composition are divided and may be contained in one of the two components or in both components. Furthermore, the division of the further ingredients, especially of the solid ingredients, may depend on the proportions in which they are to be contained in the composition. By appropriate division, it is optionally possible to achieve a higher proportion relative to the total composition. The fire-protection additive may then be contained as the total mixture or divided into individual components in one component or several components. The components are divided in a way that depends on the compatibility of the compounds contained in the composition, so that neither a reaction with one another or mutual interference of the compounds contained in the composition nor a reaction of these compounds with the compounds of the other ingredients can take place. This depends on the compounds being used.

Further subject matter of the invention is the use of an inventive composition for foaming of openings, cable and pipe penetrations in walls, floors and/or ceilings, of joints between ceilings and wall parts, between masonry openings and construction parts to be installed, such as window and door frames, between ceilings and walls and between outside walls and curtain-wall facades of buildings for the purpose of fire protection.

Further subject matter of the invention is a method for manufacturing foam manufacturing, in which the components of a foam system described in the foregoing are mixed with one another at or dose to the point of use and the mixture is introduced or applied at the desired place, for example in a gap, in a cavity or on a surface. This is the case of so-called foam-in-place foams.

Further subject matter of the invention are molded blocks, which can be obtained by the method just described, wherein the foam may be manufactured in a mold, for example, in this context it is conceivable to use a molded block to manufacture molded blocks that will be inserted in masonry openings, e.g. cable bulkheads. Other preferred uses include the bulkheading of cables, pipes, busbars and/or joints. They may also be used preferably as seals for fire protection and for manufacture of fire-protection adhesive compounds, for coating of surfaces and for manufacture of sandwich building parts or composite panels.

The molded blocks foam up in the fire situation and consequently flame propagation is prevented, thus making them suitable as sealing elements, safety devices, fire barriers or claddings. They may therefore be used as grouting and as seals for cable penetrations as well as for sealing of masonry openings. The use of a fire-protection element as the inner coating of fire-retardant doors, which foams up in the fire situation and has an insulating effect, may also be considered, as may the manufacture of door seals and other seals that foam up in the fire situation and seal the slit in front of them.

The invention will be explained in more detail hereinafter on the basis of some examples.

### EXEMPLARY EMBODIMENTS

The individual components listed in Examples 1 and 2 are respectively mixed and homogenized. For use, these mixtures are mechanically mixed with one another in a container until homogeneous intermixing has been achieved and until foaming has begun.

The fire-protection properties of the compositions obtained in this way were determined by means of macro-thermomechanical analysis with a Makro-TMA 2 apparatus (developed and constructed by Hilti (HEG) & ASG (Analytik-Service Gesellschaft in Augsburg). For this purpose, round specimens with diameter d=45 mm were respectively cut out. The specimens were respectively heated to 650° C. with an imposed load of 100 g and a heating rate of 15 K/min. The stability of ash crust obtained in this way was determined with a Texture Analyzer (CT3 of Brookfield). For this purpose, the specimen was penetrated with a T7 element at a constant speed of 0.5 mm/s. The force applied to this was measured as a function of the penetration depth. The greater the force, the harder the ash crust.

### EXAMPLE 1

### Foam System Foamed by Evolution of Hydrogen

| Ingredient | Proportion [wt %] |
|---|---|
| Poly(methyl hydrogen siloxane) ¹⁾ | 5.9 |
| Tri-(2-chloroisopropyl) phosphate ²⁾ | 3.4 |
| Aliphatic silane-terminated prepolymer ³⁾ | 58.6 |
| Basic solution ⁴⁾ | 8.8 |
| Expandable graphite ⁵⁾ | 9.4 |
| Ammonium polyphosphate ⁶⁾ | 5.7 |
| Aluminum trihydrate ⁷⁾ | 1.9 |
| Monopentaerythritol ⁸⁾ | 1.5 |
| Iron oxide (Fe₂O₃) ⁹⁾ | 0.9 |
| Calcium carbonate ¹⁰⁾ | 3.2 |
| Quartz powder ¹¹⁾ | 0.5 |
| Fumed silica ¹²⁾ | 0.1 |
| Swellable layer silicate ¹³⁾ | 0.1 |

¹⁾ Poly(methyl hydrogen siloxane); VWR; Article number 818063
²⁾ Levagard ® PP (Lanxess Co.); viscosity at 20° C.: <100 mPas
³⁾ Desmoseal S XP- 2821 (Bayer Co.);
⁴⁾ From 7.4 wt % tap water and 1.3 wt % sodium hydroxide flakes, wherein the proportions are respectively relative to the total weight of the composition
⁵⁾ Nord-Min ® 351 of Nordmann-Rassmann, Hamburg, Germany;
⁶⁾ Exolit ® AP 422 of Clairant; average particle size ~15 μm
⁷⁾ ATH HN-434 of J. M. Huber Corporation, Finland)
⁸⁾ Charmor ® PM 40 of Perstorp Specialty Chemicals AB; particle size <40 μm; water content 0.1%
⁹⁾ Bayferrox 130 M of Lanxess
¹⁰⁾ OMYACARB ® 5SV of Omya
¹¹⁾ MILLISIL ® W12 of Quarzsandwerke GmbH; mean particle size 16 μm
¹²⁾ CAB-O-SIL ® TS-720 of Cabot Corporation
¹³⁾ OPTIGEL ® WX of Byk Chemie GmbH

### EXAMPLE 2

### Foam System Foamed by Carbon Dioxide

| Ingredient | Proportion |
|---|---|
| Aliphatic silane-terminated prepolymer I ¹⁾ | 22.0 |
| Aliphatic silane-terminated prepolymer II ²⁾ | 22.0 |
| Triethyl phosphate ³⁾ | 4.4 |
| Vinyltrimethoxysilane ⁴⁾ | 2.1 |
| Tap water | 11.3 |
| Calcium carbonate ⁵⁾ | 5.9 |
| Surfactant ⁶⁾ | 0.5 |
| Citric acid, anhydrous ⁷⁾ | 12.5 |
| Expandable graphite ⁸⁾ | 8.6 |
| Ammonium polyphosphate ⁹⁾ | 5.3 |
| Aluminum trihydrate ¹⁰⁾ | 1.8 |
| Monopentaerythritol ¹¹⁾ | 1.4 |
| Iron oxide (Fe₂O₃) ¹²⁾ | 0.8 |
| Dioctyltin diketanoate ¹³⁾ | 0.3 |
| p-Toluenesulfonic acid ¹⁴⁾ | 0.5 |
| Xanthan ¹⁵⁾ | 0.2 |
| Fumed silica ¹⁶⁾ | 0.4 |

¹⁾ Desmoseal S XP- 2821 of Bayer AG;
²⁾ Desmoseal S XP-2749 of Bayer AG
³⁾ Levagard ® TEP-Z of Lanxess; viscosity at 20° C.: <1.7 mPas
⁴⁾ Geniosil ® XL 10 of Wacker, dynamic viscosity at 25° C. 0.6 mPas; density at 25° C. 0.97 g/cm3
⁵⁾ OMYABOND 520-OM of Omya
⁶⁾ Glucopon 215 UP of BASF
⁷⁾ Citric acid anhydride F6000 (CAS no. 77-92-9) of BCD Chemie
⁸⁾ Nord-Min ® 351 of Nordmann-Rassmann, Hamburg, Germany;
⁹⁾ Exolit ® AP 462 of Clairant; microencapsulated with melamine resin
¹⁰⁾ ATH HN-434 of J. M. Huber Corporation, Finland)
¹¹⁾ Charmor ® PM 40 of Perstorp . . .; particle size <40 μm; water content 0.1%
¹²⁾ Bayferrox 130 M of Lanxess
¹³⁾ TIB KAT 223 of TIB Chemicals, Mannheim, Germany
¹⁴⁾ p-Toluenesulfonic acid monohydrate, CAS number 6192-52-5 of Sigma-Aldrich
¹⁵⁾ Xanthan of Kremer Pigmente, Article number 63450
¹⁶⁾ Cab-O-Sil TS-720 of Cabot

### Comparison Example

For comparison, the product CP660 of the Hilti Co. was used. This is a PU-based fire-protection foam.

TABLE 1
Results of determination of the stability of the ash crust

| | Fₘₐₓ, mN |
|---|---|
| Comparison example | 4791 |
| Example 1 | 6039 |
| Example 2 | 3266 |

As is evident from Table 1, the inventive compositions yield a solid ash crust, wherein the composition foamed with carbon dioxide forms a harder ash crust than that of the commercially available product CP 660.

### EXAMPLE 3

### Foam System Foamed by Carbon Dioxide: Fire Test

In order to be able to appraise whether the inventive compositions are suitable as fire protection bulkheading, a composition comprising the ingredients listed in the following was filled into a commercial 2-component cartridge in a mixing ratio of 3:1 and applied via a static mixer for use. In the process, the respective ingredients of the blowing-agent components were kept separate from one another and the co-cross-linking agent was kept separate from the polymers.

A fire test for cable penetrations was performed according to EN 1366-3 (Annex B). For this purpose, a cellular concrete wail with four openings of 20×20 cm and a depth of 15 cm was provided with the following penetrations; type C and E cables and an empty pipe (d=32 cm). The foam to be tested as well as a commercially available product was introduced into the openings and subjected to a 90-minute fire test. On the non-fire side, the temperatures were measured at the foam surface and at the individual cables and the pipe. The time taken for the room temperature to exceed 180° C. (T rating) was written down for individual penetration elements. OK means that T was<180° C. during the entire test.

| | |
|---|---|
| Ingredient | Proportion |

Component A

| | |
|---|---|
| Aliphatic silane-terminated prepolymer I ¹⁾ | 22.6 |
| Aliphatic silane-terminated prepolymer II ²⁾ | 22.6 |
| Tri-(2-chloroisopropyl) phosphate ³⁾ | 4.3 |
| Silicone-glycol copolymer ⁴⁾ | 0.2 |
| Dioctyltin diketanoate ⁵⁾ | 0.2 |
| Short chopped glass fibers ⁶⁾ | 1.1 |
| Calcium carbonate ⁷⁾ | 3.0 |
| Chalk ⁸⁾ | 0.6 |
| Expandable graphite ⁹⁾ | 9.9 |
| Ammonium polyphosphate ¹⁰⁾ | 6.1 |
| Aluminum trihydrate ¹¹⁾ | 2.1 |
| Monopentaerythritol ¹²⁾ | 1.5 |
| Iron oxide (Fe₂O₃) ¹³⁾ | 0.9 |

Component B

| | |
|---|---|
| Citric acid, anhydrous ¹⁴⁾ | 13.8 |
| Tap water | 9.2 |
| Apple pectin ¹⁵⁾ | 0.5 |
| Titanium dioxide ¹⁶⁾ | 0.3 |
| Monopentaerythritol ¹²⁾ | 0.3 |
| Melamine ¹⁷⁾ | 0.3 |
| Ammonium polyphosphate ¹⁰⁾ | 0.5 |

¹⁾ Desmoseal S XP 2821 of Bayer AG;
²⁾ Desmoseal S XP 2749 of Bayer AG
³⁾ Levagard ® PP (Lanxess Co.); viscosity at 20° C.: <100 mPas
⁴⁾ DABCO DC 198 of Air Products
⁵⁾ TIB KAT 223 of TIB Chemicals, Mannheim, Germany
⁶⁾ FGCS 70-30/3 of STW
⁷⁾ Socal ® 322 of SpecialChem
⁸⁾ Omyacarb 5-SV
⁹⁾ Nord-Min ® 351 of Nordmann-Rassmann, Hamburg, Germany;
¹⁰⁾ Exolit ® AP 422 of Clariant; average particle size ~15 μm
¹¹⁾ ATH HN-434 of J. M. Huber Corporation, Finland)
¹²⁾ Charmor ® PM 40 of Perstorp . . .; particle size <40 μm; water content 0.1%
¹³⁾ Bayferrox 130 M of Lanxess
¹⁴⁾ Of Sigma Aldrich (CAS no. 77-92-9)
¹⁵⁾ Pectin of Sigma Aldrich, (CAS no. 9000-69-5)
¹⁶⁾ Of Kronos Inc.
¹⁷⁾ Melamines of OCI Melamine

TABLE 2
Results from the fire test

| | Example 3 | Comparison example |
|---|---|---|
| 1. Empty pipe | OK | OK |
| 2. Type C cable | 68 min | 63 min |
| 3. Type E cable | 73 min | 74 min |
| 4. Foam surface | OK | OK |

From Table 2, it can be inferred that the foam from the inventive composition yields better fire protection than the foam from the commercially available product.

On the basis of the examples, it has been possible to show that the inventive compositions are eminently suitable as fire-protection foams.

1. A foamable, insulating-layer-forming multi-component composition, comprising at least one alkoxysilane-functional polymer, at least one insulating-layer-forming fire-protection additive, a blowing-agent mixture and a cross-linking agent,
wherein the at least one alkoxysilane-functional polymer comprises, as a terminal group and/or as a side group along a chain of the polymer, an alkoxy-functional silane group of the general formula (I)
—Si(R¹)ₘ(OR²)₃₋ₘ (I),
wherein R¹ is a linear or branched C₁-C₁₆ alkyl moiety, R² is a linear or branched C₁-C₆ alkyl moiety and m is an integer from 0 to 2,
wherein individual ingredients of the blowing-agent mixture are separated from one another to inhibit reaction prior to mixing, and the cross-linking agent is separated from the alkoxysilane-functional polymer to inhibit reaction prior to mixing.

2. The composition according to claim 1, wherein the blowing-agent mixture comprises compounds that are capable of reacting with one another, if mixed, to form carbon dioxide (CO₂), hydrogen (H₂) or oxygen (O₂).

3. The composition according to claim 2, wherein the blowing-agent mixture comprises an acid and a compound that is reactive with the acid to form carbon dioxide.

4. The composition according to claim 2, wherein the blowing-agent mixture comprises a base and a compound that comprises an Si-bound hydrogen atom.

5. The composition according to claim 1, wherein the polymer comprises a basic backbone, which is selected from the group consisting of an alkyl chain, a polyether, polyester, polyether ester, polyamide, polyurethane, polyester urethane, polyether urethane, polyether ester urethane, polyamide urethane, polyurea, polyamine, polycarbonate, polyvinyl ester, polyacrylate, polyolefin, polyisobutylene, polysulfide, rubber, neoprene, phenol resin, epoxy resin and melamine.

6. The composition according to claim 1, wherein the alkoxysilane-functional polymer comprises at least two alkoxy-functional silane groups.

7. The composition according to claim 1, wherein the cross-linking agent is water or a water-containing ingredient.

8. The composition according to claim 1, wherein the insulating-layer-forming fire-protection additive comprises at least one thermally expandable compound and/or a mixture that comprises at least one dehydrogenation catalyst, at least one gas builder and optionally at least one carbon source.

9. The composition according to claim 8, wherein the fire-protection additive further comprises an ash-crust stabilizer.

10. The composition according to claim 1, wherein the composition further comprises a further cross-linking agent as a co-cross-linking agent.

11. The composition according to claim 1, wherein the composition further comprises a catalyst.

12. The composition according to claim 11, wherein the catalyst is selected from the group consisting of metal compounds, acid compounds, and basic compounds.

13. The composition according to claim 11, wherein the catalyst is an amine compound.

14. The composition according to claim 1, wherein the composition further comprises at least one further ingredient, which is selected from the group consisting of plasticizers, water scavengers, inorganic fillers and further additives.

15. (canceled)

16. A molded block obtained by mixing together components, thereby obtaining the composition according to claim 1, then foaming the composition in a mold.

17. A foaming process, comprising foaming the composition according to claim 1, thereby obtaining a foam providing fire protection:
in an opening, a cable penetration, and/or a pipe penetration in a wall, floor, or ceiling;
in a joint between a ceiling and a wall part:
between masonry openings or construction parts;
between a ceiling and a wall; or
between an outside wall and a curtain-wall facade of a building.

18. The molded block of claim 16, wherein the molded block has a density of from 160 to 300 g/cm³.

19. The process of claim 17, wherein the foam has a density of from 160 to 300 g/cm³.

20. The composition according to claim 1, wherein the composition further comprises a filler.

21. The process of claim 17, wherein the foam is capable of forming an ash crust upon exposure to a fire.
